(19) United States
(12) Patent Application Publication
(10) Pub. No.: US 2020/0023577 A1
(43) Pub. Date: Jan. 23, 2020

(54) ANTI-NUCLEATING AGENT FOR LASER SINTERING POWDER

(71) Applicant: BASF SE, Ludwigshafen am Rheim (DE)

(72) Inventors: Rainer OSTERMANN, Recklinghausen (DE); Claus GABRIEL, Ludwigshafen am Rhein (DE); Thomas MEIER, Ludwigshafen am Rhein (DE); Simon GRAMLICH, Ludwigshafen am Rhein (DE)

(21) Appl. No.: 15/999,529

(22) PCT Filed: Feb. 16, 2017
(86) PCT No.: PCT/EP2017/053500

§ 371 Date: Aug. 17, 2018

(30) Foreign Application Priority Data
Feb. 19, 2016 (EP) 16156537.9

(51) Int. Cl. B29C 64/153; C08L 77/02; C08L 77/06; C08K 5/46; C08K 5/3465; C08K 5/357

(52) U.S. Cl. CPC B29C 64/153; C08L 77/02; C08L 77/06; B33Y 70/00; C08K 5/3465; C08K 5/357; C08K 5/46

(57) ABSTRACT

The present invention relates to a process for producing shaped bodies by selective laser sintering of a sinter powder (SP) comprising a polyamide (P) and 0.1% to 5% by weight of at least one additive (A). The present invention also relates to shaped bodies comprising polyamide (P) and 0.1% to 5% by weight of at least one additive (A). The present invention further relates to the production of sinter powders (SP) comprising polyamide (P) and 0.1% to 5% by weight of at least one additive (A).

The present invention relates to a process for producing shaped bodies by selective laser sintering of a sinter powder (SP) comprising a polyamide (P) and 0.1% to 5% by weight of at least one additive (A). The present invention also relates to shaped bodies comprising polyamide (P) and 0.1% to 5% by weight of at least one additive (A). The present invention further relates to the production of sinter powders (SP) comprising polyamide (P) and 0.1% to 5% by weight of at least one additive (A).

The rapid provision of prototypes is a problem which has frequently occurred in recent times. One process which is particularly suitable for this “rapid prototyping” is selective laser sintering. This involves selectively exposing a polymer powder in a chamber to a laser beam. The powder melts, and the molten particles coalesce and solidify again.

Repeated application of polymer powder and the subsequent exposure to a laser enables the modeling of three-dimensional shaped bodies.

The process of laser sintering for production of shaped bodies from pulverulent polymers is described in detail in patent specifications U.S. Pat. No. 6,136,948 and WO 96/06881.

Suitable polymers for the selective laser sintering process should have a high differential between the melting temperature and the solidification temperature (crystallization temperature). EP 0911142 A1 describes nylon-12 powder (PA 12) for the production of shaped bodies by laser sintering. These powders have a melting temperature of 185 to 189° C., an enthalpy of fusion of 112 kJ/mol and a solidification temperature of 138 to 143° C. A disadvantage of the use of the polymers described in EP 0911142 A1 is the formation of extended crystallite structures in the course of cooling of the moldings, since elevated shrinkage or even warpage of the parts is observed as a result. This warpage makes it difficult to use or further process the components thus obtained. Even during the production of the moldings, the warpage can be so severe that further layer application is impossible and the production process has to be stopped. Another disadvantage is that the nylon-12 powder used according to EP 0911142 A1 can be reused only with difficulty. During the laser sintering, only a portion of the nylon-12 powder is melted. The unmolten powder should ideally be reused. However, the flowability of the melt of the nylon-12 powder decreases with increasing number of laser sintering cycles, and the melt viscosity increases. This makes it difficult to reuse the nylon-12 powder, and makes the process described in EP 0911142 A1 costly because of the high nylon-12 powder consumption. U.S. Pat. No. 6,395,809 B1 discloses the use of water-insoluble nigrosin powder in a semicrystalline polymer comprising polyamide, polyethylene terephthalate, polybutylene terephthalate or polyphenylene sulfide. Nigrosin can firstly be used as dye, and secondly also to lower the crystallization temperature of the polymer. The water-insoluble nigrosins are prepared proceeding from commercially available nigrosins by treatment with sulfuric acid and/or phosphoric acid. Preference is given to using 20% to 40% by weight of nigrosin in order to obtain products having particularly high color density. A disadvantage of the water-insoluble nigrosins used is the additional process step in which the commercially available nigrosins have to be reacted with sulfuric acid and/or phosphoric acid to give the water-insoluble nigrosins.

It is an object of the present invention to provide a process for producing shaped bodies by selective laser sintering, which has the aforementioned disadvantages of the prior art only to a lesser degree, if at all. The process shall be performable in a simple and inexpensive manner, and the shaped bodies obtained shall especially have minimum warpage (called “curling”).

This object is achieved by a process for producing shaped bodies by selective laser sintering of a sinter powder (SP) comprising a polyamide (P) and 0.1% to 5% by weight of at least one additive (A), based on the total weight of the sinter powder (SP), wherein the at least one additive (A) is selected from the group consisting of compounds of the formula (I)

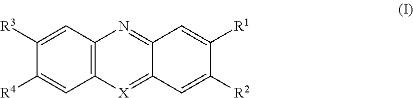

in which

R¹ and R² are independently selected from the group consisting of H, C₁-to C₁₀-alkyl, C₆-to C₁₀-aryl and NR⁵R⁶,

where R⁵ and R⁶ are independently selected from the group consisting of H, C₁-to C₁₀-alkyl and C₆-to C₁₀-aryl,

or R¹ and R² together form a unit of the formula (Ia) or (Ib)

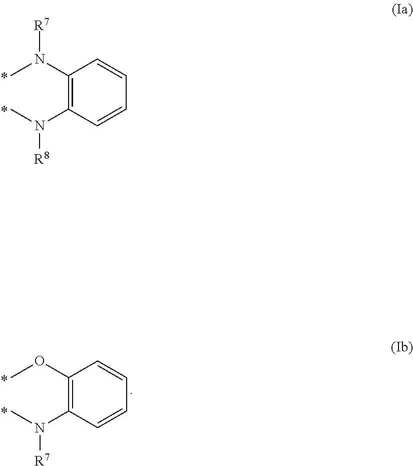

in which

R⁷ and R⁸ are independently selected from the group consisting of H, C₁-to C₁₀-alkyl and C₆-to C₁₀-aryl;

R³ and R⁴ are independently selected from the group consisting of H, C₁-to C₁₀-alkyl, C₆-to C₁₀-aryl and NR⁹R¹⁰,

where R⁹ and R¹⁰ are independently selected from the group consisting of H, C₁-to C₁₀-to alkyl and C₆-to C₁₀-aryl,

or R³ and R⁴ together form a unit of the formula (Ic) or (Id)

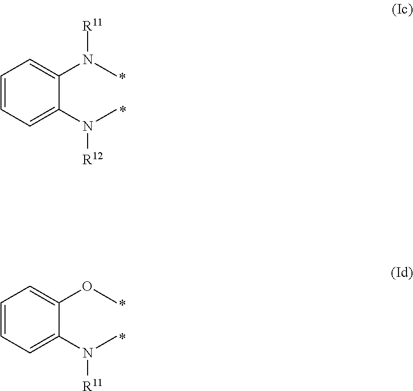

in which

R¹¹ and R¹² are independently selected from the group consisting of H, C₁-to C₁₀-alkyl and C₆-to C₁₀-aryl;

X is N, O⁺, S⁺ or N+R¹³,

where R¹³ is selected from the group consisting of H, C₁-to C₁₀-alkyl and C₆-to C₁₀-alkyl,

where the compounds of the formula (I) have a positive charge when X is O⁺, S⁺ or N+R¹³ and the compounds of the formula (I) then comprise an anion Y⁻,

where Y⁻ is selected from the group consisting of hydroxide, chloride, bromide, iodide, sulfate, sulfite, phosphate and phosphite.

It has been found that, surprisingly, a sinter powder (SP) comprising a polyamide (P) and 0.1% to 5% by weight of the at least one additive (A) has such a broadened sintering window (W_{SP}) that the shaped body produced by selective laser sintering of the sinter powder (SP) has distinctly reduced warpage, if any. It has also been found that, surprisingly, the shaped bodies produced by the process of the invention have improved color stability.

The sinter powders (SP) produced in accordance with the invention additionally have high sphericity and more homogeneous and smoother surfaces than the sinter powders described in the prior art. As a result, a more homogeneous melt film is formed during the laser sintering process, which likewise leads to distinctly lower warpage of the shaped bodies. In addition, shaped bodies having better-defined surfaces are obtained as a result.

It is also advantageous that sinter powder (SP) not melted in the production of the shaped body can be reused. Even after several laser sintering cycles, the sinter powder (SP) has similarly advantageous sintering properties to those in the first sintering cycle.

Selective Laser Sintering

The process of selective laser sintering is known per se to the person skilled in the art, for example from U.S. Pat. No. 6,136,948 and WO 96/06881.

In laser sintering a first layer of a sinterable powder is arranged in a powder bed and briefly locally exposed to a laser beam. Only the portion of the sinterable powder exposed to the laser beam is selectively melted (selective laser sintering). The molten sinterable powder coalesces and thus forms a homogeneous melt in the exposed region. The region subsequently cools down again and the sinterable powder resolidifies. The powder bed is then lowered by the layer thickness of the first layer, and a second layer of the sinterable powder is applied and selectively exposed and melted with the laser. This firstly joins the upper second layer of the sinterable powder with the lower first layer; the particles of the sinterable powder within the second layer are also joined to one another by the melting. By repeating the lowering of the powder bed, the application of the sinterable powder and the melting of the sinterable powder, it is possible to produce three-dimensional shaped bodies. The selective exposure of certain locations to the laser beam makes it possible to produce shaped bodies also having cavities for example. No additional support material is necessary since the unmolten sinterable powder itself acts as a support material.

Suitable sinterable powders are all powders that are known to those skilled in the art and can be melted by exposure to a laser. Examples of sinterable powders are the sinter powder (SP) of the invention and the polyamide (P) present in the sinter powder (SP).

The terms “sinterable powder” and “sinter powder (SP)” can be used synonymously in the context of the present invention and in that case have the same meaning.

Suitable lasers for selective laser sintering are, for example, fiber lasers, Nd:YAG lasers (neodymium-doped yttrium aluminum garnet lasers) and carbon dioxide lasers.

Of particular importance in the selective laser sintering process is the melting range of the sinterable powder, called the “sintering window (W)”. When the sinterable powder is the sinter powder (SP) of the invention, the sintering window (W) is referred to in the context of the present invention as “sintering window (W_{SP})” of the sinter powder (SP). When the sinterable powder is the polyamide (P) present in the sinter powder (SP), the sintering window (W) is referred to in the context of the present invention as “sintering window (W_{P})” of the polyamide (P).

The sintering window (W) of a sinterable powder can be determined, for example, by differential scanning calorimetry, DSC.

25

In differential scanning calorimetry, the temperature of a sample, i.e. in the present case a sample of the sinterable powder, and the temperature of a reference are altered in a linear manner with time. For this purpose, heat is supplied to/removed from the sample and the reference. The amount of heat Q necessary to keep the sample at the same temperature as the reference is determined. The amount of heat Q_{R} supplied to/removed from the reference serves as a reference value.

If the sample undergoes an endothermic phase transformation, an additional amount of heat Q has to be supplied to keep the sample at the same temperature as the reference. If an exothermic phase transformation takes place, an amount of heat Q has to be removed to keep the sample at the same temperature as the reference. The measurement affords a DSC diagram in which the amount of heat Q supplied to/removed from the sample is plotted as a function of temperature T.

Measurement typically involves initially performing a heating run (H), i.e. the sample and the reference are heated in a linear manner. During the melting of the sample (solid/liquid phase transformation), an additional amount of heat Q has to be supplied to keep the sample at the same temperature as the reference. A peak is then observed in the DSC diagram, called the melting peak.

After the heating run (H), a cooling run (C) is typically measured. This involves cooling the sample and the reference in a linear manner, i.e. heat is removed from the sample and the reference. During the crystallization/solidification of the sample (liquid/solid phase transformation), a greater amount of heat Q has to be removed to keep the sample at the same temperature as the reference, since heat is liberated in the course of crystallization/solidification. In the DSC diagram of the cooling run (C), a peak, called the crystallization peak, is then observed in the opposite direction from the melting peak.

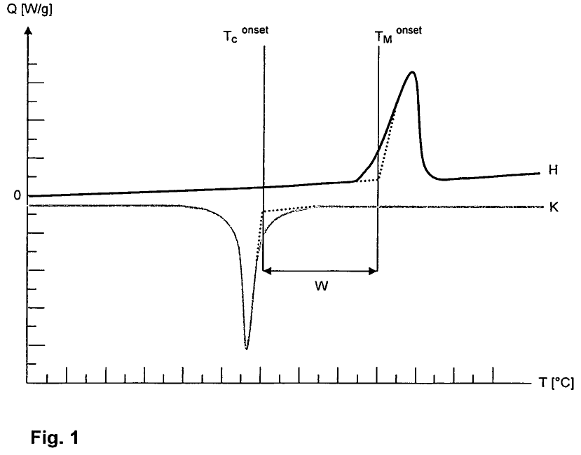

Such a DSC diagram comprising a heating run (H) and a cooling run (C) is depicted by way of example in FIG. 1. The DSC diagram can be used to determine the onset temperature of melting (T_{M}^{onset}) and the onset temperature of crystallization (T_{C}^{onset}).

To determine the onset temperature of melting (T_{M}^{onset}), a tangent is drawn against the baseline of the heating run (H) at the temperatures below the melting peak. A second tangent is drawn against the first point of inflection of the melting peak at temperatures below the temperature at the maximum of the melting peak. The two tangents are extrapolated until they intersect. The vertical extrapolation of the intersection to the temperature axis denotes the onset temperature of melting (T_{M}^{onset}).

To determine the onset temperature of crystallization (T_{C}^{onset}), a tangent is drawn against the baseline of the cooling run (C) at the temperatures above the crystallization peak. A second tangent is drawn against the point of inflection of the crystallization peak at temperatures above the temperature at the minimum of the crystallization peak. The two tangents are extrapolated until they intersect. The vertical extrapolation of the intersection to the temperature axis denotes the onset temperature of crystallization (T_{C}^{onset}).

The sintering window (W) is the difference between the onset temperature of melting (T_{M}^{onset}) and the onset temperature of crystallization (T_{c}^{onset}). Thus:

W=T_{M}^{onset}−T_{C}^{onset}

In the context of the present invention, the terms “sintering window (W)”, “size of the sintering window (W)” and “difference between the onset temperature of melting (T_{M}^{onset}) and the onset temperature of crystallization (T_{M}^{onset})” have the same meaning and are used synonymously.

The determination of the sintering window (W_{SP}) of the sinter powder (SP) and the determination of the sintering window (W_{P}) of the polyamide (P) are effected as described above. The sample used in that case for determination of the sintering window (W_{SP}) of the sinter powder (SP) is the sinter powder (SP), and the sample used for determination of the sintering window (W_{P}) of the polyamide (P) is the polyamide (P).

Sinter Powder

The sintering window (W_{SP}) of the sinter powder (SP) should be as large as possible in order to avoid premature crystallization or premature solidification of the melt during selective laser sintering, since this can lead to warpage of the shaped body obtained. This effect is also referred to as “curling”.

In one embodiment of the invention, the sintering window (W_{SP}) of the sinter powder (SP) is at least 10° C., preferably at least 15° C., more preferably at least 20° C. and especially preferably at least 25° C.

The sintering window (W) is frequently also stated in K (Kelvin) rather than in ° C. (degrees Celsius). 1 K=1° C.

In a preferred embodiment, the sinter powder (SP) has a sintering window (W_{SP}) at least 5%, preferably at least 10% and especially preferably at least 20% larger than the sintering window (W_{P}) of the polyamide (P) present in the sinter powder (SP).

The present invention thus also provides a process in which the sinter powder (SP) has a sintering window (W_{SP}) and the polyamide (P) present in the sinter powder (SP) has a sintering window (W_{P}), where the sintering window (W_{SP}; W_{P}) in each case is the difference between the onset temperature of the melting (T_{M}^{onset}) and the onset temperature of the crystallization (T_{C}^{onset}), and where the sintering window (W_{SP}) of the sinter powder (SP) is at least 5% larger than the sintering window (W_{P}) of the polyamide (P) present in the sinter powder (SP).

This means that the difference (ΔW) between the sintering window (W_{SP}) of the sinter powder (SP) and the sintering window (W_{P}) of the polyamide (P) present in the sinter powder (SP) is, for example, at least 3° C., preferably at least 5° C. and especially preferably at least 10° C.

ΔW=W_{SP}−W_{P}.

The difference (ΔW) between the sintering window (W_{SP}) of the sinter powder (SP) and the sintering window (W_{P}) of the polyamide (P) present in the sinter powder (SP) is, for example, in the range from 3 to 20° C., preferably in the range from 8 to 20° C. and especially preferably in the range from 12 to 20° C.

In respect of the sintering window (W_{SP}) of the sinter powder (SP) and the sintering window (W_{P}) of the polyamide (P) and in respect of the determination thereof, the above-described details and preferences for the sintering window (W) apply correspondingly.

It will be clear to the person skilled in the art that the onset temperature of the melting (T_{M}^{onset}) and the onset temperature of the crystallization (T_{C}^{onset}) both of the sinter powder (SP) and of the polyamide (P) are dependent on the type of polyamide (P).

For example, the onset temperature of the melting (T_{M}^{onset}) of the polyamide (P) for nylon-6 (PA6) as polyamide (P) is in the range from 205 to 215° C., and the onset temperature of the crystallization (T_{C}^{onset}) of the polyamide (P) for PA6 as polyamide (P) is in the range from 189 to 192° C. Thus, the sintering window (W_{P}), i.e. the difference between the onset temperature of the melting (T_{M}^{onset}) and the onset temperature of the crystallization (T_{C}^{onset}) of the polyamide (P) for PA6 as polyamide (P) is in the range from 14 to 25° C.

For example, the onset temperature of the melting (T_{M}^{onset}) of the sinter powder (SP) for PA6 as polyamide (P) present in the sinter powder (SP) is in the range from 205 to 215° C., and the onset temperature of the crystallization (T_{C}^{onset}) of the sinter powder (SP) for PA6 as polyamide (P) present in the sinter powder (SP) is in the range from 173 to 178° C. Thus, the sintering window (W_{SP}), i.e. the difference between the onset temperature of the melting (T_{M}^{onset}) and the onset temperature of the crystallization (T_{C}^{onset}) of the sinter powder (SP) for PA6 as polyamide (P) present in the sinter powder (SP) is in the range from 32 to 36° C.

For example, the onset temperature of the melting (T_{M}^{onset}) of the polyamide (P) for nylon-6,10 (PA6.10) as polyamide (P) is in the range from 212 to 215° C., and the onset temperature of the crystallization (T_{C}^{onset}) of the polyamide (P) for PA6.10 as polyamide (P) is in the range from 194 to 196° C. Thus, the sintering window (W_{P}), i.e. the difference between the onset temperature of the melting (T_{M}^{onset}) and the onset temperature of the crystallization (T_{C}^{onset}) of the polyamide (P) for PA6.10 as polyamide (P) is in the range from 16 to 21° C. e

For example, the onset temperature of the melting (T_{M}^{onset}) of the sinter powder (SP) for PA6.10 as polyamide (P) present in the sinter powder (SP) is in the range from 211 to 214° C., and the onset temperature of the crystallization (T_{C}^{onset}) of the sinter powder (SP) for PA6.10 as polyamide (P) present in the sinter powder (SP) is in the range from 187 to 189° C. Thus, the sintering window (W_{SP}), i.e. the difference between the onset temperature of the melting (T_{M}^{onset}) and the onset temperature of the crystallization (T_{C}^{onset}), of the sinter powder (SP) for PA6.10 as polyamide (P) present in the sinter powder (SP) is in the range from 22 to 27° C.

For example, the onset temperature of the melting (T_{M}^{onset}) of the polyamide (P) for nylon-6,6 (PA6.6) as polyamide (P) is in the range from 248 to 250° C., and the onset temperature of the crystallization (T_{C}^{onset}) of the polyamide (P) for PA6.6 as polyamide (P) is in the range from 234 to 236° C. Thus, the sintering window (W_{P}), i.e. the difference between the onset temperature of the melting (T_{M}^{onset}) and the onset temperature of the crystallization (T_{C}^{onset}), of the polyamide (P) for PA6.6 as polyamide (P) is in the range from 12 to 16° C.

For example, the onset temperature of the melting (T_{M}^{onset}) of the sinter powder (SP) for PA6.6 as polyamide (P) present in the sinter powder (SP) is in the range from 246 to 248° C., and the onset temperature of the crystallization (T_{C}^{onset}) of the sinter powder (SP) for PA6.6 as polyamide (P) present in the sinter powder (SP) is in the range from 224 to 226° C. Thus, the sintering window (W_{SP}), i.e. the difference between the onset temperature of the melting (T_{M}^{onset}) and the onset temperature of the crystallization (T_{C}^{onset}), of the sinter powder (SP) for PA6.6 as polyamide (P) present in the sinter powder (SP) is in the range from 20 to 24° C.

The above embodiments and preferences always apply under the assumption that the onset temperature of the melting (T_{C}^{onset}) is above the onset temperature of the crystallization (T_{C}^{onset}) i.e. that T_{M}onset>T_{c}^{onset}.

According to the invention, the sinter powder (SP) comprises a polyamide (P) and 0.1% to 5% by weight of at least one additive (A) selected from the group consisting of compounds of the formula (I), based on the total weight of the sinter powder (SP).

Preferably, the sinter powder (SP) comprises 0.5% to 2.5% by weight of the at least one additive (A), and, more preferably, the sinter powder (SP) comprises 0.5% to 1% by⁻weight of the at least one additive (A), based in each case on the total weight of the sinter powder (SP).

According to the invention, the size of the particles of the sinter powder (SP) is generally in the range from 10 to 250 μm, preferably from 30 to 200 μm, more preferably from 50 to 120 μm, especially preferably from 50 to 90 μm.

The present invention thus also provides a process in which the particle size of the sinter powder (SP) is in the range from 10 to 250 μm.

The sinter powders (SP) of the invention generally have

a D10 in the range from 10 to 30 μm,

a D50 in the range from 25 to 70 μm and

D90 in the range from 50 to 150 μm.

In a preferred embodiment, the sinter powders (SP) have

a D10 in the range from 20 to 30 μm,

a D50 in the range from 40 to 60 μm and

a D90 in the range from 80 to 100 μm.

In the context of the present invention, “D10” in this connection is understood to mean the particle size at which 10% by volume of the particles based on the total volume of the particles are smaller than or equal to D10 and 90% by volume of the particles based on the total volume of the particles are larger than D10. By analogy, “D50” is understood to mean the particle size at which 50% by volume of the particles based on the total volume of the particles are smaller than or equal to D50 and 50% by volume of the particles based on the total volume of the particles are larger than D50. By analogy, “D90” is understood to mean the particle size at which 90% by volume of the particles based on the total volume of the particles are smaller than or equal to D90 and 10% by volume of the particles based on the total volume of the particles are larger than D90.

To determine the particle sizes, the sinter powder (SP) is suspended in a dry state using compressed air or in a solvent, for example water or ethanol, and the suspension is analyzed. D10, D50 and D90 are determined by laser diffraction using a Malvern Mastersizer 2000. The evaluation is effected by means of Fraunhofer diffraction.

In a further embodiment of the process of the invention, the at least one additive (A) is selected from the group consisting of lithium chloride and compounds of the formula (I).

In that case, the sinter powder (SP) comprises a polyamide (P) and 0.1% to 5% by weight of at least one additive (A) selected from the group consisting of lithium chloride and compounds of the formula (I), based on the total weight of the sinter powder (SP).

For production of the sinter powder (SP), the polyamide (P) and the at least one additive (A) are mixed.

After the mixing, the polyamide (P) and the at least one additive (A) may be present in the sinter powder (SP) as separate particles alongside one another. In a preferred embodiment of the invention, the polyamide (P) comprises the at least one additive (A).

In other words, in a preferred embodiment of the invention, the sinter powder (SP) comprises the polyamide (P) which comprises the at least one additive (A). The at least one additive (A) may be in homogeneous or inhomogeneous distribution in the particles of the polyamide (P). Whether the at least one additive (A) is in homogeneous or inhomogeneous distribution in the particles of the polyamide (P) depends on the production process for the sinter powder (SP). In addition, the at least one additive (A) may be applied to the surface of the particles of the polyamide (P).

If the at least one additive (A) is homogeneously distributed in the particles of the polyamide (P), the at least one additive (A) may, for example, be dissolved in the particles of the polyamide (P). The at least one additive (A) may then be molecularly dispersed in the particles of the polyamide (P). The at least one additive (A) may then likewise be finely distributed in the particles of the polyamide (P).

When the at least one additive (A) is homogeneously distributed in the particles of the polyamide (P), the size of the particles of the at least one additive (A) is, for example, in the range from 0.5 nm to 1000 nm, preferably in the range from 0.5 nm to 500 nm, more preferably in the range from 1 nm to 250 nm.

If the at least one additive (A) is inhomogeneously distributed in the particles of the polyamide (P), the at least one additive (A) may, for example, be in undissolved form, for example in particulate form, in the particles of the polyamide (P). It is also possible that the at least one additive (A) adheres to the surface of the particles of the polyamide (P).

When the at least one additive (A) is inhomogeneously distributed in the particles of the polyamide (P), the size of the particles of the at least one additive (A) is, for example, in the range from>1000 nm to 10 000 nm, preferably in the range from>1000 nm to 5000 nm, more preferably in the range from 1500 nm to 2500 nm.

The manner of distribution of the additive (A) in the polyamide (P) is not essential to the invention. It is preferable merely that the additive (A) is present in or on the particles of the polyamide (P).

Suitable methods for production of a sinter powder (SP) in which the at least one additive (A) is distributed in the particles of the polyamide (P) are in principle all methods known to those skilled in the art.

For example, the at least one additive (A) can be mixed with the polyamide (P), and at least the polyamide (P) can be melted before, during or after the addition of the at least one additive (A). The mixing and/or melting can be effected, for example, in an extruder. Subsequently, the melt comprising a mixture of polyamide (P) and the at least one additive (A) can be extruded. After cooling, a solidified polyamide/additive mixture is obtained. This mixture can subsequently, for example, be ground by methods known to those skilled in the art, in order to obtain the sinter powder (SP). The grinding can be effected, for example, in sifter mills, in opposed jet mills, in ball mills, in hammer mills, in vibratory mills or in rotor mills.

It is also possible to produce the sinter powder (SP) by precipitation. This is preferred. For this purpose, the polyamide (P) is mixed with a solvent (S) and the polyamide (P) is dissolved in the solvent (S), optionally while heating, to obtain a polyamide solution (PS). The polyamide (P) may be partly or fully dissolved in the solvent (S). The polyamide (P) is preferably fully dissolved in the solvent (S). It is thus preferable to obtain a polyamide solution (PS) comprising the polyamide (P) fully dissolved in the solvent (S).

The at least one additive (A) is added to the mixture of polyamide (P) and solvent (S). The juncture of addition of the at least one additive (A) is unimportant here, but the addition generally precedes the precipitation of the sinter powder (SP). The at least one additive (A) can be added to the solvent (S) before the polyamide (P) is mixed with the solvent (S). It is likewise possible to add the at least one additive (A) to the mixture of polyamide (P) and solvent (S) before the polyamide (P) is dissolved in the solvent (S). In addition, it is also possible to add the at least one additive (A) to the polyamide solution (PS).

Subsequently, the sinter powder (SP) can be precipitated out of the polyamide solution (PS) comprising the at least one additive (A).

The precipitation can be effected by methods known to those skilled in the art. For example, the sinter powder (SP) can be precipitated by cooling the polyamide solution (PS) comprising the at least one additive (A), distilling the solvent (S) out of the polyamide solution (PS) comprising the at least one additive (A), or adding a precipitant (PR) to the polyamide solution (PS) comprising the at least one additive (A). Preferably, the sinter powder (SP) is precipitated by cooling the polyamide solution (PS) comprising the at least one additive (A).

If the sinter powder (SP) is precipitated by cooling the polyamide solution (PS) comprising the at least one additive (A), the polyamide solution (PS) can be stirred, for example, during cooling in order to produce particularly fine sinter powder (SP) particles.

In a further preferred embodiment, the sinter powder (SP) is produced by precipitating with a precipitant (PR).

For this purpose, the polyamide (P) is first mixed with a solvent (S) and dissolved in the solvent (S), optionally while heating, to obtain a polyamide solution (PS) comprising the at least one additive (A).

The juncture of addition of the at least one additive (A) is not essential to the invention. What is essential to the invention is merely that the polyamide solution, prior to the addition of the precipitant (PR), comprises the at least one additive (A). In a preferred embodiment, the at least one additive (A) is likewise dissolved in the solvent (S) prior to the precipitation.

The solvent (S) used may be exactly one solvent; it is likewise possible to use two or more solvents as solvent (S).

Suitable solvents (S) are, for example, selected from the group consisting of alcohols, lactams and ketones. The solvent (S) is preferably selected from the group consisting of alcohols and lactams.

The invention also provides a process for producing the sinter powder (SP), in which the solvent (S) is selected from the group consisting of alcohol, lactam and ketone.

According to the invention, “lactam” is understood to mean cyclic amides having 3 to 12 carbon atoms in the ring, preferably 4 to 6 carbon atoms. Examples of suitable lactams are selected from the group consisting of 3-aminopropanolactam (β-lactam; β-propiolactam), 4-aminobutanolactam (γ-lactam; γ-butyrolactam), 5-aminopentanolactam (δ-lactam; δ-valerolactam), δ-aminohexanolactam (ε-lactam; ε-caprolactam), 7-aminoheptanolactam (ζ-lactam; ζ-heptanolactam), 8-aminooctanolactam (η-lactam; η-octanolactam), 9-nonanolactam (θ-lactam; θ-nonanolactam), 10-decanolactam (ω-decanolactam), 11-undecanolactam (ω-undecanolactam), and 12-dodecanolactam (ω-dodecanolactam).

The lactams may be unsubstituted or at least monosubstituted. If at least monosubstituted lactams are used, the nitrogen atom and/or the ring carbon atoms thereof may bear one, two, or more substituents selected independently from the group consisting of C₁-to C₁₀-alkyl, C₅-to C₆-cycloalkyl, and C₅-to C₁₀-aryl.

Suitable C₁-to C₁₀-alkyl substituents are, for example, methyl, ethyl, propyl, isopropyl, n-butyl, sec-butyl, and tert-butyl. A suitable C₅-to C₆-cycloalkyl substituent is, for example, cyclohexyl. Preferred C₅-to C₁₀-aryl substituents are phenyl and anthranyl.

Preference is given to using unsubstituted lactams, preference being given to γ-lactam (γ-butyrolactam), δ-lactam (δ-valerolactam) and ε-lactam (ε-caprolactam). Particular preference is given to δ-lactam (δ-valerolactam) and ε-lactam (ε-caprolactam), ε-caprolactam being especially preferred.

The solvent (S) preferably comprises at least 55% by weight of lactam, more preferably at least 80% by weight of lactam, especially preferably at least 90% by weight of lactam and most preferably at least 98% by weight of lactam, based in each case on the total weight of the solvent (S).

Additionally most preferably, the solvent (S) consists of lactam.

It is also preferable for the solvent (S) to comprise less than 45% by weight of water, more preferably less than 20% by weight of water, especially preferably less than 10% by weight of water and most preferably less than 2% by weight of water, based in each case on the total weight of the solvent (S).

The lower limit of the water content of the solvent (S) is generally in the range from 0% to 0.5% by weight, preferably in the range from 0% to 0.3% by weight and more preferably in the range from 0% to 0.1% by weight, based in each case on the total weight of the solvent (S).

With regard to the juncture of addition of the at least one additive (A), the details described above are applicable.

As soon as the polyamide solution (PS) comprises the at least one additive (A), the sinter powder (SP) can be precipitated by addition of a precipitant (PR).

The precipitant (PR) used may be exactly one precipitant. It is likewise possible to use two or more precipitants as the precipitant (PR).

Suitable precipitants (PR) are known to those skilled in the art and are selected, for example, from the group consisting of water, methanol and ethanol.

In a preferred embodiment, the precipitant (PR) comprises at least 50% by weight of water, more preferably at least 70% by weight of water, especially preferably at least 80% by weight of water and most preferably at least 90% by weight of water, based in each case on the total weight of the precipitant (PR).

The present invention also provides a process for producing the sinter powder (SP), in which the precipitant (PR) comprises at least 50% by weight of water, based on the total weight of the precipitant (PR).

Additionally most preferably, the precipitant (PR) consists of water.

The precipitated sinter powder (SP) is then in suspended form in a solution comprising solvent (S) and precipitant (PR). The solution may also comprise unprecipitated polyamide (P) and may also comprise the at least one additive (A).

The precipitated sinter powder (SP) can be separated from this solution by methods known to those skilled in the art, for example by decanting, sieving, filtering or centrifuging.

The present invention thus also provides a process for producing shaped bodies by selective laser sintering, in which the sinter powder (SP) is produced by a process comprising the following steps:
a) dissolving a polyamide (P) in a solvent (S), with addition of the at least one additive (A) before, during and/or after the dissolution, to obtain a polyamide solution (PS) comprising the at least one additive (A),
b) adding a precipitant (PR) to the polyamide solution (PS) comprising the at least one additive (A) from process step a) to obtain a suspension comprising the sinter powder (SP) suspended in a solution comprising the solvent (S) and the precipitant (PR),
c) separating the sinter powder (SP) from the suspension obtained in process step b).

The present invention therefore also provides a process for producing a sinter powder (SP), comprising the following steps:
a) dissolving a polyamide (P) in a solvent (S), with addition of the at least one additive (A) before, during and/or after the dissolution, to obtain a polyamide solution (PS) comprising the at least one additive (A),
b) adding a precipitant (PR) to the polyamide solution (PS) comprising the at least one additive (A) from process step a) to obtain a suspension comprising the sinter powder (SP) suspended in a solution comprising the solvent (S) and the precipitant (PR),
c) separating the sinter powder (SP) from the suspension obtained in process step b).

Preference is given in accordance with the invention to the addition of the at least one additive (A) prior to process step b).

More preferably, the at least one additive (A) is added before, during and/or after the dissolution and prior to process step b). The at least one additive (A) is added in such amounts that the sinter powder (SP) obtained comprises 0.1% to 5% by weight, preferably 0.5% to 2.5% by weight and more preferably 0.5% to 1% by weight of the at least one additive (A), based on the total weight of the sinter powder (SP).

In a further preferred embodiment, the polyamide (P) is mixed with a solvent (S) in process step a) and then heated to a temperature (T₁), with addition of the at least one additive (A) before, during and/or after the heating, with dissolution of the polyamide (P) in the solvent (S), to obtain a polyamide solution (PS) comprising the at least one additive (A).

The temperature (T₁) is generally below the boiling temperature of the solvent (S) and below the melting temperature of the polyamide (P). Preferably, the temperature (T₁) is at least 50° C. below the boiling temperature of the solvent (S) and/or the melting temperature of the polyamide (P), more preferably at least 35° C. below the boiling temperature of the solvent (S) and/or the melting temperature of the polyamide (P), especially preferably at least 20° C. below the boiling temperature of the solvent (S) and/or the melting temperature of the polyamide (P), most preferably at least 20° C. below the boiling temperature of the solvent (S) and/or the melting temperature of the polyamide (P).

The temperature (T₁) is also generally above the melting temperature of the solvent (S). Preferably, the temperature (T₁) is at least 5° C. above the melting temperature of the solvent (S), more preferably at least 10° C. above the melting temperature of the solvent (S), especially preferably at least 30° C. above the melting temperature of the solvent (S).

As soon as the at least one additive (A) is present in the polyamide solution (PS), the polyamide solution (PS) comprising the at least one additive (A) can be cooled to a temperature (T₂).

The temperature (T₂) is generally above the melting temperature of the solvent (S). Preferably, the temperature (T₂) is at least 5° C. above the melting temperature of the solvent (S), more preferably at least 10° C. above the melting temperature of the solvent (S), especially preferably at least 30° C. above the melting temperature of the solvent (S).

When the polyamide solution (PS) comprising the at least one additive (A) has been cooled to the temperature (T₂), the precipitant (PR) is added and the sinter powder (SP) is precipitated. Subsequently, the sinter powder (SP) can be separated.

It is also possible that a portion of the sinter powder (SP) is already precipitated during the cooling to the temperature (T₂).

The present invention thus also provides a process for producing shaped bodies by selective laser sintering, in which the sinter powder (SP) is produced by a process comprising the following steps:
a) heating a mixture comprising a polyamide (P) and a solvent (S) to a temperature (T₁) above which the polyamide (P) dissolves in the solvent (S), with addition of the at least one additive (A) before, during and/or after the heating, to obtain a polyamide solution (PS) comprising the at least one additive (A),
b) cooling the polyamide solution (PS) which comprises the at least one additive (A) and has been obtained in process step a) to a temperature (T₂) and subsequently adding a precipitant (PR) to obtain a suspension comprising the sinter powder (SP) suspended in a solution comprising the solvent (S) and the precipitant (PR),
c) separating the sinter powder (SP) from the suspension obtained in process step b).

The present invention therefore also provides a process for producing a sinter powder (SP), comprising the following steps:
a) heating a mixture comprising a polyamide (P) and a solvent (S) to a temperature (T₁) above which the polyamide (P) dissolves in the solvent (S), with addition of the at least one additive (A) before, during and/or after the heating, to obtain a polyamide solution (PS) comprising the at least one additive (A),
b) cooling the polyamide solution (PS) which comprises the at least one additive (A) and has been obtained in process step a) to a temperature (T₂) and subsequently adding a precipitant (PR) to obtain a suspension comprising the sinter powder (SP) suspended in a solution comprising the solvent (S) and the precipitant (PR),
c) separating the sinter powder (SP) from the suspension obtained in process step b).

In relation to the solvent (S), the addition of the at least one additive (A), the precipitant (PR) and the separation of the sinter powder (SP), the details and preferences described above are applicable.

In an especially preferred embodiment, the polyamide (P) is mixed with a solvent (S) and heated to a temperature greater than a cloud temperature (T_{c}) above which the polyamide (P) is completely dissolved in the solvent (S) to obtain a polyamide solution (PS) comprising the at least one additive (A), with addition of the at least one additive (A) before, during and/or after the heating.

The cloud temperature (T_{c}) is understood to mean the temperature at and below which cloudiness of the polyamide solution (PS) is apparent. Above the cloud temperature (T_{c}), the polyamide (P) is fully dissolved in the solvent (S).

The temperature above the cloud temperature (T_{c}) to which the polyamide solution (PS) is heated is generally below the boiling temperature of the solvent (S) and below the melting temperature of the polyamide (P). Especially preferably, the mixture of polyamide (P) and solvent (S) is heated to a temperature in the range from 10 to 50° C. below the boiling temperature of the solvent (S) and/or the melting temperature of the polyamide (P), more preferably to a temperature in the range from 10 to 35° C. below the boiling temperature of the solvent (S) and/or the melting temperature of the polyamide (P) and especially to a temperature in the range from 10 to 20° C. below the boiling temperature of the solvent (S) and/or the melting temperature of the polyamide (P).

As soon as the polyamide solution (PS) comprises the at least one additive (A), the polyamide solution (PS) can be cooled to a temperature below the cloud temperature (T_{c}). Preferably, the polyamide solution (PS) comprising the at least one additive (A) is cooled to a temperature at least 0.5° C., more preferably at least 1° C., below the cloud temperature (T_{c}).

The temperature below the cloud temperature (T_{c}) to which the polyamide solution (PS) comprising the at least one additive (A) is cooled is generally above the melting temperature of the solvent (S). Preferably, the temperature is at least 5° C. above the melting temperature of the solvent (S), more preferably at least 10° C. above the melting temperature of the solvent (S), especially preferably at least 30° C. above the melting temperature of the solvent (S).

After the polyamide solution (PS) comprising the at least one additive (A) has been cooled to a temperature below the cloud temperature (T_{c}), the precipitant (PR) is added. This precipitates the sinter powder (SP). Subsequently, the sinter powder (SP) can be separated.

It is also possible that a portion of the sinter powder (SP) already precipitates out in the course of cooling of the polyamide solution (PS) comprising the at least one additive (A).

The present invention thus also provides a process for producing shaped bodies by selective laser sintering, in which the sinter powder (SP) is produced by a process comprising the following steps:
a) heating a mixture comprising a polyamide (P) and a solvent (S) to a temperature greater than the cloud temperature (T_{c}) above which the polyamide (P) dissolves completely in the solvent (S), with addition of the at least one additive (A) before, during and/or after the heating, to obtain a polyamide solution (PS) comprising the at least one additive (A),
b) cooling the polyamide solution (PS) which comprises the at least one additive (A) and has been obtained in process step a) to a temperature less than/equal to the cloud temperature (T_{c}) and subsequently adding a precipitant (PR) to obtain a suspension comprising the sinter powder (SP) suspended in a solution comprising the solvent (S) and the precipitant (PR),
c) separating the sinter powder (SP) from the suspension obtained in process step b).

The present invention therefore also provides a process for producing a sinter powder (SP), comprising the following steps:
a) heating a mixture comprising a polyamide (P) and a solvent (S) to a temperature greater than the cloud temperature (T_{C}) above which the polyamide (P) dissolves completely in the solvent (S), with addition of the at least one additive (A) before, during and/or after the heating, to obtain a polyamide solution (PS) comprising the at least one additive (A),
b) cooling the polyamide solution (PS) which comprises the at least one additive (A) and has been obtained in process step a) to a temperature of not more than the cloud temperature (T_{C}) and subsequently adding a precipitant (PR) to obtain a suspension comprising the sinter powder (SP) suspended in a solution comprising the solvent (S) and the precipitant (PR),
c) separating the sinter powder (SP) from the suspension obtained in process step b).

In relation to the solvent (S), the addition of the at least one additive (A), the precipitant (PR), and the separation of the sinter powder (SP), the details and preferences described above are applicable.

The present invention thus also provides a process for producing shaped bodies by selective laser sintering, in which the sinter powder (SP) is produced by a process comprising the following steps:
a) heating a mixture comprising a polyamide (P) and a lactam to a temperature greater than a cloud temperature (T_{c}) above which the polyamide (P) dissolves completely in the lactam, with addition of the at least one additive (A) before, during and/or after the heating, to obtain a melt comprising the polyamide (P) fully dissolved in the lactam,
b) cooling the melt obtained in process step a) to a temperature of not more than the cloud temperature (T_{c}) and subsequently adding water to obtain a suspension comprising the sinter powder (SP) suspended in a solution comprising the water and the lactam, and
c) separating the sinter powder (SP) from the suspension obtained in process step b).

The present invention therefore also provides a process for producing a sinter powder (SP), comprising the following steps:
a) heating a mixture comprising a polyamide (P) and a lactam to a temperature greater than a cloud temperature (T_{c}) above which the polyamide (P) dissolves completely in the lactam, with addition of the at least one additive (A) before, during and/or after the heating, to obtain a melt comprising the polyamide (P) fully dissolved in the lactam,
b) cooling the melt obtained in process step a) to a temperature of not more than the cloud temperature (T_{c}) and subsequently adding water to obtain a suspension comprising the sinter powder (SP) suspended in a solution comprising the water and the lactam, and
c) separating the sinter powder (SP) from the suspension obtained in process step b).

The precipitation of the sinter powder (SP) with a precipitant (PR) affords particularly narrow particle size distributions. It has also been found that, surprisingly, sinter powders (SP) which have been produced by this process have particularly high sphericity and homogeneous and smooth surfaces and are of particularly good suitability for production of shaped bodies by means of selective laser sintering, since they form very homogeneous melt films.

A high sphericity means that the particles have a particularly round shape. A measure used for this is what is called the sphericity value (SPHT). The sphericity of the particles of the sinter powder (SP) here indicates the ratio of the surface area of the particles of the sinter powder (SP) to the surface area of ideal spheres of the same volume. The sphericity can be determined by image analysis, for example with the aid of a Camsizer.

The sinter powders (SP) obtainable by the process of the invention generally have a sphericity in the range from 0.4 to 1.0.

A measure of the breadth of the particle size distribution is the difference between the D90 and D10 values (D90 minus D10). The closer these two values are to one another, i.e. the smaller the difference, the narrower the particle size distribution.

The sinter powders (SP) obtainable by the process described above generally have values in the range from 10 to 100 μm, preferably in the range from 10 to 50 μm, for the difference between D90 and D10.

Narrow particle size distributions can also be obtained by sieving the particles of the sinter powder (SP) produced by one of the processes specified above or by separating them by size, for example by windsifting. Further processes for separating by particle size are known as such to those skilled in the art.

In a further preferred embodiment of the present invention, the sinter powder (SP) is prepared by first dissolving the polyamide (P) in the solvent (S) to obtain a solution.

The dissolution can be effected by any methods known to those skilled in the art, for example as described above, but it is preferable not to add the at least one additive (A). The polyamide (P) is subsequently precipitated out of the solution and dried to obtain a powder of the polyamide (P). Suitable methods of precipitation include all methods known to those skilled in the art, for example those described above for the polyamide solution (PS).

The obtained powder of the polyamide (P) is then contacted with a solution of the at least one additive (A) and subsequently dried to obtain the sinter powder (SP). Suitable solvents in the solution of the at least one additive (A) are all solvents that are known to those skilled in the art and dissolve the at least one additive (A) and preferably dissolve the polyamide (P) sparingly, if at all, examples being water and/or alcohols. Suitable methods of contacting the powder of the polyamide (P) with the solution of the at least one additive (A) are likewise all methods known to those skilled in the art. The contacting is typically effected at temperatures in the range from 10 to 30° C.

The sinter powder (SP) may, as well as polyamide (P) and the at least one additive (A); comprise further additives (B). With regard to the production of sinter powders (SP) comprising further additives (B), the details and preferences with regard to the additive (A) are correspondingly applicable.

Processes for producing sinter powders comprising further additives (B) are known as such to those skilled in the art. For example, the further additives (B) can be mixed and/or precipitated with the polyamide (P) together with the at least one additive (A) as described above.

If the further additives (B) are present separately as individual particles in addition to the polyamide (P) particles present in the sinter powder (SP), it is particularly preferable when the further additives (B) have a similar particle size to the polyamide (P) particles present in the sinter powder (SP). “A similar particle size” is understood in accordance with the invention to mean that the particle size differs by not more than +/− 20 μm, preferably not more than +/− 10 μm and more preferably not more than +/− 5 μm from the particle size of the polyamide (P).

Suitable further additives (B) are selected, for example, from the group consisting of inorganic pigments such as transition metal oxides, stabilizers such as phenol, talc, alkaline earth metal silicates and alkaline earth metal glycerophosphates, fillers such as glass beads, glass fibers, carbon fibers, nanotubes and chalk, impact-modified polymers, especially those based on ethylene-propylene (EPM) or ethylene-propylene-diene (EPDM) rubbers or thermoplastic polyurethanes, flame retardants, plasticizers and adhesion promoters.

The sinter powder (SP) may comprise 0% to 20% by weight of further additives (B); preferably, the sinter powder (SP) comprises 0% to 10% by weight of further additives (B), especially preferably 0% to 5% by weight of further additives (B), based in each case on the total weight of the sinter powder (SP).

The Sinter Powder (SP) Generally Comprises

79.5% to 99.5% by weight of polyamide (P),

0.5% to 2.5% by weight of the at least one additive (A) and

optionally 0% to 20% by weight of further additives (B),

where the percentages by weight are each based on the total weight of the sinter powder (SP).

Preferably, the sinter powder (SP) comprises

89.5% to 99.5% by weight of polyamide (P),

0.5% to 2.0% by weight of the at least one additive (A) and

0% to 10% by weight of further additives (B),

where the percentages by weight are each based on the total weight of the sinter powder (SP).

More Preferably, the Sinter Powder (SP) Comprises

94.5% to 99.5% by weight of polyamide (P),

0.5% to 2.0% by weight of the at least one additive (A) and 0% to 5% by weight of further additives (B),

where the percentages by weight are each based on the total weight of the sinter powder (SP).

Especially preferably, the Sinter Powder (SP) Comprises

98.0% to 99.5% by weight of polyamide (P) and 0.5% to 2.0% by weight of the at least one additive (A),

where the percentages by weight are each based on the total weight of the sinter powder (SP).

The sum total of the percentages by weight of the polyamide (P), the at least one additive (A) and the further additives (B) generally adds up to 100% by weight.

Polyamide

The polyamide (P) used may be exactly one polyamide (P). It is also possible to use mixtures of two or more polyamides (P). Preference is given to using exactly one polyamide (P).

Suitable polyamides (P) generally have a viscosity number of 70 to 350 mLg, preferably of 70 to 240 mLg. According to the invention, the viscosity number is determined from a 0.5% by weight solution of the polyamide (P) in 96% by weight sulfuric acid at 25° C. according to ISO 307.

Preferred polyamides (P) are semicrystalline polyamides. Suitable polyamides (P) have a weight-average molecular weight (M_{w}) in the range from 500 to 2 000 000 g/mol, preferably in the range from 5000 to 500 000 g/mol and more preferably in the range from 10 000 to 100 000 g/mol. The weight-average molecular weight (M_{w}) is determined according to ASTM D4001.

Suitable polyamides (P) are for example polyamides (P) which derive from lactams having 7 to 13 ring members. Suitable polyamides (P) further include polyamides (P) obtained by reaction of dicarboxylic acids with diamines.

Examples of polyamides (P) which derive from lactams include polyamides which derive from polycaprolactam, polycaprylolactam and/or polylaurolactam.

Suitable polyamides (P) further include those obtainable from ω-aminoalkylnitriles. A preferred co-aminoalkylnitrile is aminocapronitrile, which leads to nylon-6. In addition, dinitriles can be reacted with diamine. Preference is given here to adiponitrile and hexamethylenediamine which polymerize to give nylon-6,6. The polymerization of nitriles is effected in the presence of water and is also referred to as direct polymerization.

When polyamides (P) obtainable from dicarboxylic acids and diamines are used, dicarboxyalkanes (aliphatic dicarboxylic acids) having 6 to 36 carbon atoms, preferably 6 to 12 carbon atoms and more preferably 6 to 10 carbon atoms may be employed. Aromatic dicarboxylic acids are also suitable.

Examples of dicarboxylic acids include adipic acid, azelaic acid, sebacic acid, dodecanedioic acid and also terephthalic acid and/or isophthalic acid.

Suitable diamines include for example alkanediamines having 4 to 36 carbon atoms, preferably alkanediamines having 6 to 12 carbon atoms, in particular alkanediamines having 6 to 8 carbon atoms, and aromatic diamines, for example m-xylylenediamine, di(4-aminophenyl)methane, di(4-aminocyclohexyl)methane, 2,2-di(4-aminophenyl)propane, 2,2-di(4-aminocyclohexyl)propane and 1,5-diamino-2-methylpentane.

Preferred polyamides (P) are polyhexamethyleneadipamide, polyhexamethylenesebacamide and polycaprolactam and also nylon-6/6,6, in particular having a proportion of caprolactam units of 5% to 95% by weight.

Also suitable are polyamides (P) obtainable by copolymerization of two or more of the monomers mentioned hereinabove and hereinbelow or mixtures of a plurality of polyamides (P) in any desired mixing ratio. Particularly preferred mixtures are mixtures of nylon-6,6 with other polyamides (P), in particular nylon-6/6,6.

Suitable polyamides (P) are accordingly aliphatic, semiaromatic or aromatic polyamides (P). The term “aliphatic polyamides” is understood to mean that the polyamides (P) are formed exclusively from aliphatic monomers. The term “semiaromatic polyamides” is understood to mean that the polyamides (P) are formed from both aliphatic and aromatic monomers. The term “aromatic polyamides” is understood to mean that the polyamides (P) are formed exclusively from aromatic monomers.

The nonexhaustive list which follows comprises the aforementioned polyamides (P) and further polyam ides (P) that are suitable for use in the process of the invention and the monomers present.

AB polymers:

| | |
|---|---|
| PA 4 | pyrrolidone |
| PA 6 | ε-caprolactam |
| PA 7 | enantholactam |
| PA 8 | caprylolactam |
| PA 9 | 9-aminopelargonic acid |
| PA 11 | 11-aminoundecanoic acid |
| PA 12 | laurolactam |

AA/BB polymers:

| | |
|---|---|
| PA 46 | tetramethylenediamine, adipic acid |
| PA 66 | hexamethylenediamine, adipic acid |
| PA 69 | hexamethylenediamine, azelaic acid |
| PA 610 | hexamethylenediamine, sebacic acid |
| PA 612 | hexamethylenediamine, decanedicarboxylic acid |
| PA 613 | hexamethylenediamine, undecanedicarboxylic acid |
| PA 1212 | dodecane-1,12-diamine, decanedicarboxylic acid |
| PA 1313 | tridecane-1,13-diamine, undecanedicarboxylic acid |
| PA 6T | hexamethylenediamine, terephthalic acid |
| PA 9T | nonyldiamine, terephthalic acid |
| PA MXD6 | m-xylylenediamine, adipic acid |
| PA 6I | hexamethylenediamine, isophthalic acid |
| PA 6-3-T | trimethylhexamethylenediamine, terephthalic acid |
| PA 6/6T | (see PA 6 and PA 6T) |
| PA 6/66 | (see PA 6 and PA 66) |
| PA 6/12 | (see PA 6 and PA 12) |
| PA 66/6/610 | (see PA 66, PA 6 and PA 610) |
| PA 6I/6T | (see PA 6I and PA 6T) |
| PA PACM 12 | diaminodicyclohexylmethane, laurolactam |
| PA 6I/6T/PACM | as PA 6I/6T and diaminodicyclohexylmethane |
| PA 12/MACMI | laurolactam, dimethyldiaminodicyclohexylmethane, |
| | isophthalic acid |
| PA 12/MACMT | laurolactam, dimethyldiaminodicyclohexylmethane, |
| | terephthalic acid |
| PA PDA-T | phenylenediamine, terephthalic acid |

The present invention thus also provides a process in which the polyamide (P) is at least one polyamide selected from the group consisting of PA 4, PA 6, PA 7, PA 8, PA 9, PA 11, PA 12, PA 46, PA 66, PA 69, PA 610, PA 612, PA 613, PA 1212, PA1313, PA 6T, PA MXD6, PA 6I, PA 6-3-T, PA 6/6T, PA 6/66, PA 66/6, PA 6/12, PA 66/6/610, PA 6l/6T, PA PACM 12, PA 61/6T/PACM, PA 12/MACMI, PA 12/MACMT, PA PDA-T and copolyam ides composed of two or more of the aforementioned polyamides.

Preferably, the polyamide (P) is at least one polyamide selected from the group consisting of nylon-6 (PA 6), nylon-6,6 (PA 66), nylon-6/6,6 (PA 6/66), nylon-6,10 (PA 610), nylon-6/6T (PA 6/6T), nylon-12 (PA12) and nylon-12,12 (PA1212).

Particularly preferred polyamides (P) are nylon-6 (PA 6) and/or nylon-6,6 (PA 66), with especial preference for nylon-6 (PA 6).

The present invention thus also provides a process in which the polyamide is at least one polyamide selected from the group consisting of nylon-6 (PA 6), nylon-6,6 (PA 66), nylon-6/6,6 (PA 6/66), nylon-6,6/6 (PA 66/6), nylon-6,10 (PA 610), nylon-6/6T (PA 6/6T), nylon-12 (PA 12) and nylon-12,12 (PA 1212).

Additive (A)

The at least one additive (A) used in accordance with the invention is also referred to as antinucleating agent.

According to the invention, the at least one additive (A) is selected from the group consisting of compounds of the formula (I)

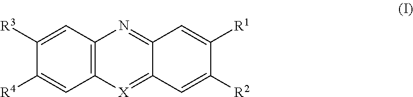

in which

R′ and R² are independently selected from the group consisting of H, C₁-to C₁₀-alkyl, C₆-to C₁₀-aryl and NR⁵R⁶,
where R⁵ and R⁶ are independently selected from the group consisting of H, C₁-to C₁₀-alkyl and C6-to C₁₀-aryl,
or R¹ and R² together form a unit of the formula (la) or (Ib)

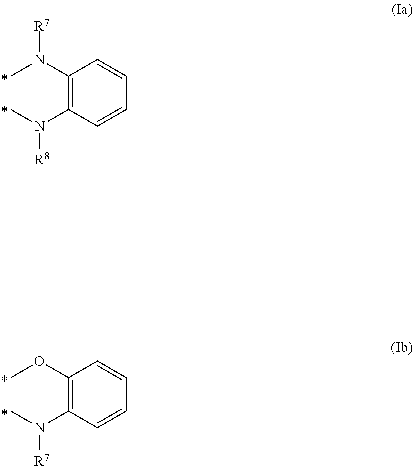

in which
R⁷ and R⁸ are independently selected from the group consisting of H, C₁-to C₁₀-alkyl and C₆-to C₁₀-aryl;

R³ and R⁴ are independently selected from the group consisting of H, C₁- to C₁₀-alkyl, C6- to C₆-aryl and NR⁹R¹⁰,
where R⁹ and R¹⁰ are independently selected from the group consisting of H, C₁-to C₁₀-alkyl and C₆-to C₁₀-aryl,
or R³ and R⁴ together form a unit of the formula (Ic) or (Id)

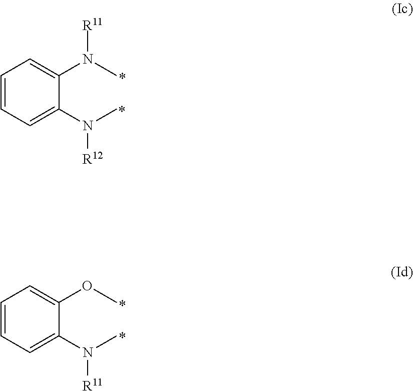

in which
R¹¹ and R¹² are independently selected from the group consisting of H, C₁-to C₁₀-alkyl and C₆-to C₁₀-aryl;

X is N, O,⁻, S⁺ or N⁺R¹³,
where R¹³ is selected from the group consisting of H, C₁-to C₁₀-alkyl and C₆-to C₁₀-aryl,
where the compounds of the formula (I) have a positive charge when X is O⁺, S⁺ or N⁺893 R¹³ and the compounds of the formula (I) then comprise an anion Y⁻,
where Y⁻ is selected from the group consisting of hydroxide, chloride, bromide, iodide, sulfate, sulfite, phosphate and phosphite.

It will be clear to those skilled in the art that, when the compound of the formula (I) has a positive charge, the anion Y⁻ present in the formula (I) generally compensates for the positive charge. This means that, for example, when the compound of the formula (I) has a positive charge and the anion Y⁻ is chloride, the positive charge of the formula (I) and the negative charge of the anion Y⁻ compensate for one another. When the compound of the formula (I) has a positive charge and the anion Y⁻ is phosphate, for example, the anion bears a triple negative charge. One of the charges compensates for the positive charge of the compound of the formula (I); the remaining two negative charges compensate for the positive charges of further compounds of the formula (I). This is known to those skilled in the art.

In a preferred embodiment, in compounds of the formula (I),

R¹ and R² are independently selected from the group consisting of H, C₁-to C₄-alkyl, phenyl and NR⁵R⁶,
where R⁵ and R⁶ are independently selected from the group consisting of H, C₁-to C₄-alkyl and phenyl,
or R¹ and R² together form a unit of the formula (la) or (Ib) in which

R⁷ and R⁸ are independently selected from the group consisting of H, C₁-to C₄-alkyl and phenyl;

R³ and R⁴ are independently selected from the group consisting of H, C₁-to C₄-alkyl, phenyl and NR⁹R¹⁰,
where R⁹ and R¹° are independently selected from the group consisting of H, C₁-to C₄-alkyl and phenyl,
or R³ and R⁴ together form a unit of the formula (Ic) or (Id) in which
R¹¹ and R¹² are independently selected from the group consisting of H, C₁-to C₄-alkyl and phenyl;

X is N, S⁺ or N⁺R¹³,
where R¹³ is selected from the group consisting of H, C₁-to C₄-alkyl and phenyl,
where the compounds of the formula (I) have a positive charge when X is S⁺ or N⁺R¹³ and the compounds of the formula (I) then comprise an anion Y⁻,
where Y⁻ is selected from the group consisting of hydroxide, chloride, bromide, iodide, sulfate, sulfite, phosphate and phosphite.

In a further preferred embodiment, in compounds of the formula (I),

R¹ and R² are independently selected from the group consisting of H, C₁-to C₄-alkyl and NR⁵R⁶,
where R⁵ and R⁶ are independently selected from the group consisting of H and C₁-to C₄-alkyl;

R³ and R⁴ are independently selected from the group consisting of H, C₁-to C₄-alkyl and NR⁹R¹⁰,
where R⁹ and R¹⁰ are independently selected from the group consisting of H and C₁-to C₄-alkyl;

X is N, S⁺ or N⁺R¹³,
where R¹³ is selected from the group consisting of H and C¹-to C⁴-alkyl,
where the compounds of the formula (I) have a positive charge when X is S⁺ or N⁺R¹³ and the compounds of the formula (I) then comprise an anion Y⁻,
where Y⁻ is selected from the group consisting of hydroxide, chloride, bromide, iodide, sulfate, sulfite, phosphate and phosphite.

In a particularly preferred embodiment, in compounds of the formula (I),

R¹ and R² are independently selected from the group consisting of H, methyl and NR⁵R⁶,
where R⁵ and R⁶ are independently selected from the group consisting of H, methyl and phenyl,
or R¹ and R² together form a unit of the formula (le) or (If)

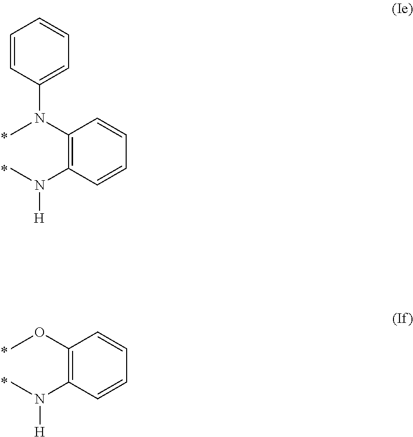

R³ and R⁴ are independently selected from the group consisting of H, methyl and NR⁹R¹⁰,
where R⁹ and R¹⁰ are independently selected from the group consisting of H, methyl and phenyl, p1 or R³ and R⁴ together form a unit of the formula (Ig) or (lh)

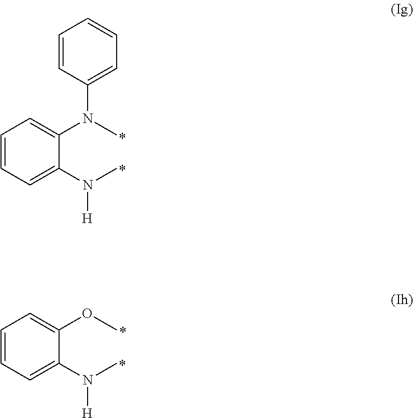

X is N, S⁺ or N⁺R¹³,
where R¹³ is phenyl,
where the compounds of the formula (I) have a positive charge when X is S⁺ or N⁺R¹³ and the compounds of the formula (I) then comprise an anion Y⁻,
where Y⁻ is selected from the group consisting of hydroxide and chloride.

When the formula (I) has a positive charge, the anion Y⁻ is preferably selected from the group consisting of hydroxide and chloride.

The present invention thus also provides a process in which X in compounds of the formula (I) is N, O⁺, S⁺ or N⁺R¹³, where the compounds of the formula (I) have a positive charge when X is O⁺, S⁺ or N⁺R¹³ and the compounds of the formula (I) then comprise an anion Y⁻, where Y⁻ is selected from the group consisting of hydroxide and chloride.

In the context of the present invention, hydroxide is understood to mean OH⁻, chloride to mean Cl⁻, bromide to mean Br⁻, iodide to mean l⁻, sulfate to mean SO₄²⁻, sulfite to mean SO₃²⁻, phosphate to mean PO₄³⁻, and phosphite to mean PO₃³⁻.

In the context of the present invention, C₁-to C₁₀-alkyl is understood to mean aliphatic hydrocarbonradicals having 1 to 10 carbon atoms. These may be in branched or unbranched form. Aliphatic hydrocarbonradicals having 1 to 10 carbon atoms are, for example, selected from the group consisting of methyl, ethyl, propyl, isopropyl, butyl, isobutyl and tert-butyl.

In one embodiment of the present invention, the C₁-to C₁₀-alkyls may also be substituted. Suitable substituents are, for example, selected from the group consisting of F, CI, Br, OH, CN, NH₂ and C₁-to C -alkyl. Preferably, the C₁-to C₁₀-alkyls are unsubstituted.

In the context of the present invention, C₆-to C₁₀-aryl is understood to mean an aromatic ring system having 6 to 10 carbons. The aromatic ring system may be monocyclic or bicyclic. Examples of C₆-to C₁₀-aryls are phenyl and naphthyl. The C₆-to C₁₀-aryls may additionally be substituted. Suitable substituents are, for example, selected from the group consisting of F, CI, Br, OH, CN, NH₂ and C₁-to C₁₀-alkyl. Preferably, the C₆-to C₁₀-aryls are unsubstituted.

In the formula (Ia), (Ib), (Ic) and (Id), “*” denotes the bond to the carbon atom in formula (I) to which the radical is bonded. The formulae (Ib), (Id), (le), (If), (Ig) and (Ih) do of course also include the isomeric compounds of the formulae (Ib′), (Id′), (Ie′), (If′), (Ig′) and (Ih′)

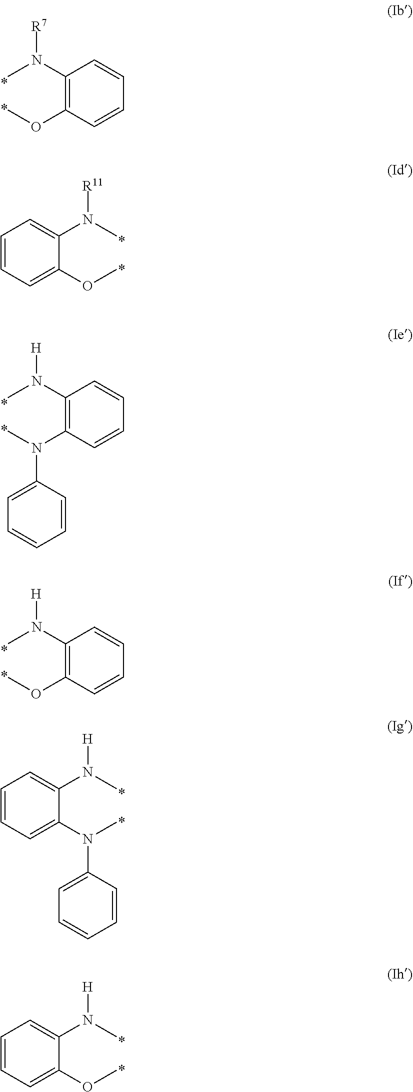

According to the invention, the formulae (Ib), (Id), (le), (If), (Ig) and (1h) do of course also comprise the corresponding mesomeric compounds.

If R¹ and R² together form a unit of the formula (la), compounds of the formula (I) comprise compounds of the formula (11)

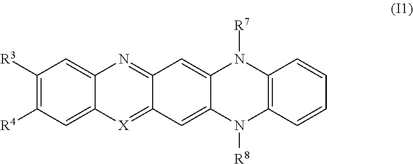

in which

R³ and R⁴ are independently selected from the group consisting of H, C₁- to C₁₀-alkyl, C₆-to C₁₀-aryl and NR⁹R¹⁰,
where R⁹ and R¹⁰ are independently selected from the group consisting of H, C₁-to C₁₀-alkyl and C₆-to C₁₀-aryl,
or R³ and R⁴ together form a unit of the formula (Ic) or (Id)
in which
R¹¹ and R¹² are independently selected from the group consisting of H, C₁₋-to C₁₀-alkyl and C₆-to C₁₀-aryl;

R⁷ and R⁸ are independently selected from the group consisting of H, C₁- to C₁₀ -alkyl and C₆-to C₁₀-aryl;

X is N, O⁺, S⁺ or N⁺R¹³,
where R¹³ is selected from the group consisting of H, C₁-to C₁₀-alkyl and C₆-to C₁₀-aryl,
where the compounds of the formula (I) have a positive charge when X is O⁺, S⁺ or N⁺R¹³ and the compounds of the formula (I) then comprise an anion Y⁻,
where Y⁻ is selected from the group consisting of hydroxide, chloride, bromide, iodide, sulfate, sulfite, phosphate and phosphite.

If R¹ and R² together form a unit of the formula (Ib), compounds of the formula (I) comprise compounds of the formula (I2)

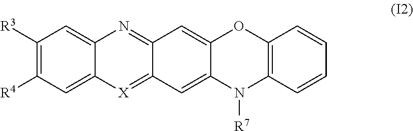

in which

R³ and R⁴ are independently selected from the group consisting of H, C₁-to C₁₀-alkyl, C₆-to C₁₀-aryl and NR⁹R¹⁰,
where R⁹ and R¹⁰ are independently selected from the group consisting of H, C₁-to C₁₀-alkyl and C₆-to C₁₀-aryl,
or R³ and R⁴ together form a unit of the formula (Ic) or (Id)
in which
R¹¹ and R¹² are independently selected from the group consisting of H, C₁-to C₁₀-alkyl and C₆-to C₁₀-aryl;

R⁷ is selected from the group consisting of H, C₁- to C₁₀-alkyl and C₆-to C₁₀-aryl;

X is N, O⁺, S⁺ or N⁺R¹³,
where R¹³ is selected from the group consisting of H, C₁-to C₁₀-alkyl and C₆-to C₁₀-aryl,
where the compounds of the formula (I) have a positive charge when X is O⁺, S⁺ or N⁺R¹³ and the compounds of the formula (I) then comprise an anion Y⁻,
where Y⁻ is selected from the group consisting of hydroxide, chloride, bromide, iodide, sulfate, sulfite, phosphate and phosphite.

If R³ and R⁴ together form a unit of the formula (Ic), compounds of the formula (I) comprise compounds of the formula (I3)

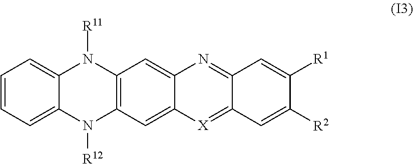

in which

R¹ and R² are independently selected from the group consisting of H, C₁-to C₁₀-alkyl, C₆-to C₁₀-aryl and NR⁵R⁶,
where R⁵ and R⁶ are independently selected from the group consisting of H, C¹-to C₁₀-alkyl and C₆-to C₁₀-aryl,
or R¹ and R² together form a unit of the formula (la) or (Ib)
in which
R⁷ and R⁸ are independently selected from the group consisting of H, C¹-to C₁₀-alkyl and C₆-to C₁₀-aryl;

R¹¹ and R¹² are independently selected from the group consisting of H, C₁-to C₁₀-alkyl and C₆-to C₁₀-aryl;

X is N, O⁺, S⁺ or N⁺R¹³,
where R¹³ is selected from the group consisting of H, C₁-to C₁₀-alkyl and C₆-to C₁₀ -aryl,
where the compounds of the formula (I) have a positive charge when X is O⁺, S⁺ or N⁺R¹³ and the compounds of the formula (I) then comprise an anion Y⁻,
where Y⁻ is selected from the group consisting of hydroxide, chloride, bromide, iodide, sulfate, sulfite, phosphate and phosphite.

If R³ and R⁴ together form a unit of the formula (Id), compounds of the formula (I) comprise compounds of the formula (14)

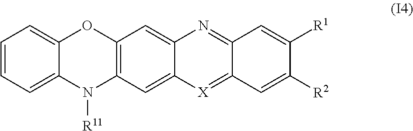

in which

R¹ and R² are independently selected from the group consisting of H, C₁-to C₁₀-alkyl, C₆-to C₁₀-aryl and NR⁵R⁶,
where R⁵ and R⁶ are independently selected from the group consisting of H, C1-to C₁₀-alkyl and C₆-to C₁₀-aryl,
or R¹ and R² together form a unit of the formula (Ia) or (Ib)
in which
R⁷ and R⁸ are independently selected from the group consisting of H, C₁-to C₁₀-alkyl, and C₆-to C₁₀-aryl,

R¹¹ is selected from the group consisting of H, C₁-to C₁₀-alkyl and C6-to C₁₀-aryl;

X is N, O⁺, S⁺ or N⁺ R¹³,
where R¹³ is selected from the group consisting of H, C₁-to C₁₀-alkyl and C₆-to C₁₀-aryl,
where the compounds of the formula (I) have a positive charge when X is O⁺, S⁺ or N⁺R¹³ and the compounds of the formula (I) then comprise an anion
where Y⁻ is selected from the group consisting of hydroxide, chloride, bromide, iodide, sulfate, sulfite, phosphate and phosphite.

In a particularly preferred embodiment, the at least one additive (A) is selected from the group consisting of compounds of the formula (II), of the formula (III), of the formula (IV), of the formula (V), of the formula (VI), of the formula (VII), of the formula (VIII) and of the formula (IX)

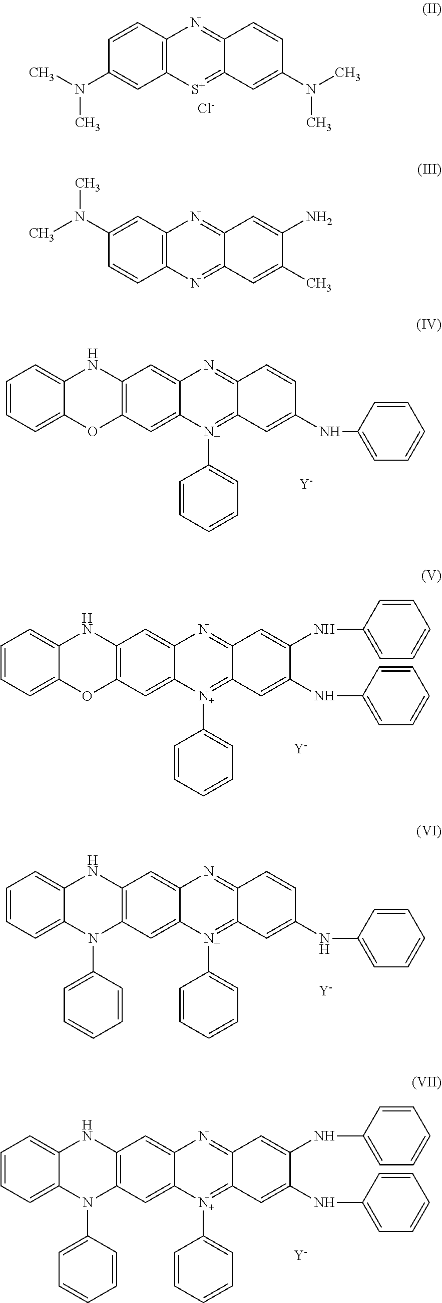

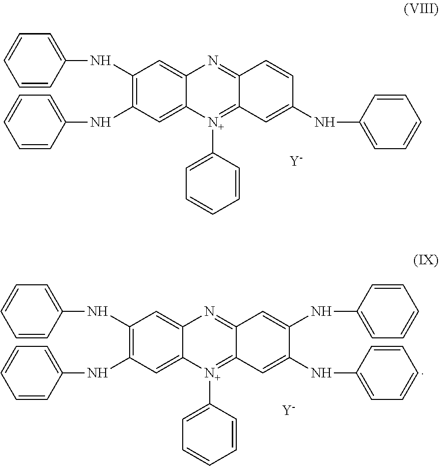

where, in the compounds of the formula (IV), of the formula (V), of the formula (VI), of the formula (VII), of the formula (VIII) and of the formula (IX), Y⁻ is selected from the group consisting of hydroxide, chloride, bromide, iodide, sulfate, sulfite, phosphate and phosphite. Preferably, Y⁻ is selected from the group consisting of hydroxide and chloride.

The compound of the formula (II) is a dye also known as methylene blue. Other names are N,N,N′,N′-tetramethylenethionine chloride and basic blue 9 (Color Index 52015; CAS number 61-73-4/122965-43-9).

The compound of the formula (III) is a dye also known as neutral red. Neutral red is also known by the name 3-amino-7-dimethylamino-2-methylphenazine hydrochloride/tolylene red (Color Index 50040; CAS number 553-24-2).

The compounds of the formulae (IV) to (IX) are nigrosin. The latter is prepared, for example, by heating nitrobenzene, aniline and aniline hydrochloride in the presence of copper or iron. Nigrosin is a synthetic black or gray dye also known as “Solvent Black 5” (Color Index 50415). The main constituents of nigrosin are compounds of the formulae (IV) to (IX).

In a preferred embodiment, the at least one additive (A) is selected from the group consisting of nigrosin, methylene blue and neutral red.

The present invention thus also provides a process in which the at least one additive (A) is selected from the group consisting of nigrosin, methylene blue and neutral red.

In a further preferred embodiment, the at least one additive (A) is selected from the group consisting of nigrosin, methylene blue and neutral red.

In a further preferred embodiment, the at least one additive (A) is selected from the group consisting of methylene blue and neutral red.

In a further embodiment, the at least one additive (A) is selected from the group consisting of lithium chloride, nigrosin, methylene blue and neutral red.

In a further embodiment, the at least one additive (A) is selected from the group consisting of lithium chloride and nigrosin.

Shaped Body

The shaped bodies of the invention are obtained by the process of selective laser sintering described further up.

The sinter powder (SP) melted by the laser in the selective exposure resolidifies after the exposure and thus forms the shaped bodies of the invention. The shaped bodies can be removed from the powder bed directly after the solidification; it is likewise possible first to cool the shaped bodies and only then to remove them from the powder bed. Any adhering polymer particles can be mechanically removed from the surface by known methods. Methods for surface treatment of the shaped bodies include, for example, vibratory grinding or barrel polishing, and also sandblasting, glass bead blasting or microbead blasting.

It is also possible to subject the shaped bodies obtained to further processing or, for example, to treat the surface, for example by painting the shaped bodies.

The shaped bodies of the invention comprise a polyamide (P) and 0.1% to 5% by weight of at least one additive (A), preferably in the range from 0.5% to 2.5% by weight and especially preferably in the range from 0.5% to 1% by weight of the at least one additive (A), based in each case on the total weight of the shaped body. According to the invention, the at least one additive (A) is the at least one additive (A) that was present in the sinter powder (SP), and the polyamide (P) is the polyamide (P) that was present in the sinter powder (SP).

In addition, the shaped body may comprise further additives (B). The further additives (B) are the further additives (B) that were already present in the sinter powder (SP).

In one embodiment of the invention, the shaped body comprises 0% to 50% by weight of further additives (B), based on the total weight of the shaped body. In a preferred embodiment, it comprises 0% to 30% by weight of further additives (B); in a particularly preferred embodiment, it comprises 0% to 20% by weight of further additives (B); the shaped body especially preferably comprises 0% to 5% by weight of further additives (B), based in each case on the total weight of the shaped body.

The present invention also provides a process for producing shaped bodies by selective laser sintering, in which the sinter powder (SP) is produced by the process of the invention for producing a sinter powder (SP).

In respect of this process for producing shaped bodies by selective laser sintering, the details and preferences described above are correspondingly applicable.

The present invention thus also provides a shaped body obtainable by the process of the invention.

### EXAMPLES

The following components were used:

Polyamide (P):

| | |
|---|---|
| (P1) nylon-12 | (PA2200, EOS) |
| (P2) nylon-6 | (Ultramid ® B27, BASF SE) |
| (P3) nylon-6,10 | (Ultramid ® S3k Balance, BASF SE) |
| (P4) nylon-6,6 | (Ultramid ® A27, BASF SE) |

Additive (A):

| | |
|---|---|
| (A1) nigrosin | (Orient Chemical) |
| (A2) neutral red | (3-amino-7-dimethylamino-2-methylphenazine |
| | hydrochloride; Carl Roth) |
| (A3) lithium chloride | |

Production of the Sinter Powder

Table 1 indicates whether the sinter powder has been produced by precipitation or by grinding.

For the sinter powders produced by grinding, the components reported in table 1 were compounded in the ratio specified in table 1 in a twin-screw extruder (ZSK 40) at a speed of 200 rpm, a barrel temperature of 240° C. and a throughput of 50 kg/h with subsequent extrudate pelletization. The thus obtained pelletized material was subjected to cryogenic grinding to obtain the sinter powder (SP).

To produce the sinter powder by precipitation, the polyamide (P) was dissolved in the amounts specified in table 1 in a solvent consisting of 40% by weight of caprolactam and 60% by weight of water, based in each case on the total weight of the solvent, using a temperature ramp of 2 hours at 120° C., 2 hours at 160° C. and 0.5 hours at 175° C., and subsequently precipitated by cooling. After washing with water and drying, the polyamide (P) was obtained as a powder. The thus obtained powder of the polyamide (P) was subsequently contacted with a solution of the additive (A), using the polyamide (P) and the additive (A) in the ratio specified in table 1. The solvent used in the solution of the additive (A) was ethanol for nigrosin as additive (A); water was used for neutral red or lithium chloride as additive (A). After drying, the sinter powder (SP) was obtained.

TABLE 1

| | (P1) | (P2) | (P3) | (P4) | (A1) | (A2) | (A3) | |
|---|---|---|---|---|---|---|---|---|
| | [% by | [% by | [% by | [% by | [% by | [% by | [% by | |
| Example | wt.] | wt.] | wt.] | wt.] | wt.] | wt.] | wt.] | Production |
| C1 | 100 | — | — | — | — | — | — | — |
| C2 | — | 100 | — | — | — | — | — | grinding |
| I3 | — | 99.24 | — | — | 0.76 | — | — | grinding |
| I4 | — | 97.5 | — | — | 2.5 | — | — | grinding |
| C5 | — | 100 | — | — | — | — | — | precipitation |
| C6 | — | 100 | — | — | — | — | — | precipitation |
| I7 | — | 99.25 | — | — | 0.75 | — | — | precipitation |
| I8 | — | 99.5 | — | — | — | 0.5 | — | precipitation |
| I9 | — | 99.75 | — | — | — | 0.25 | — | precipitation |
| I10 | — | 99.875 | — | — | — | 0.125 | — | precipitation |
| C11 | — | 99.75 | — | — | — | — | 0.25 | precipitation |
| C12 | — | — | 100 | — | — | — | — | — |
| I13 | — | — | 99.24 | — | 0.76 | — | — | grinding |
| C14 | — | — | — | 100 | — | — | — | — |
| I15 | — | — | — | 99.24 | 0.76 | — | — | grinding |

The onset temperature of melting (T_{M}^{onset}) and the onset temperature of crystallization (T_{C}^{onset}) of the sinter powder were determined as described for FIG. 1. This was used to determine the sintering window (W).

Tensile bars were also produced to determine warpage.

Production of Tensile Bars

The sinter powders were introduced with a layer thickness of 0.1 mm into the cavity at the temperature specified in table 2. The sinter powder was subsequently exposed to a laser with the laser power output specified in table 2 and the point spacing specified, with the speed of the laser over the sample during exposure as specified in table 2. The point spacing is also known as laser track spacing or lane spacing. Selective laser sintering typically involves scanning in stripes. The point spacing gives the distance between the centers of the stripes, i.e. between the two centers of the laser beam for two stripes.

TABLE 2

| | | Laser | | |
|---|---|---|---|---|
| | | power | Laser | Point |
| | Temperature | output | speed | spacing |
| Example | [° C.] | [W] | [m/s] | [mm] |
| C1 | 171 | 11 | 5 | 0.15 |
| C2 | — | — | — | — |
| I3 | 200 | 20 | 5 | 0.25 |
| I4 | 194 | 25 | 5 | 0.15 |
| C5 | 201 | 23 | 5 | 0.2 |
| C6 | 202 | 25 | 5 | 0.2 |
| I7 | — | — | — | — |
| I8 | 208 | 15 | 5 | 0.15 |
| I9 | 208 | 15 | 5 | 0.15 |
| I10 | — | — | — | — |
| C11 | — | — | — | — |
| C12 | — | — | — | — |
| I13 | 202 | 20 | 5 | 0.15 |
| C14 | — | — | — | — |
| I15 | — | — | — | — |

Determination of Warpage

To determine the warpage of the sintered bars obtained, the sintered bar was placed concave side down on a planar surface. The distance (am) between the planar surface and the upper edge of the middle of the sintered bar was determined. In addition, the thickness (dm) in the middle of the sintered bar was determined. Warpage in % is then determined by the following formula:

W=100·(aₘ-dₘ)/dₘ

The dimensions of the sintered bars were typically length 80 mm, width 10 mm and thickness 4 mm.

The results for the measurement of the sintering window (W) and of warpage are reported in table 3.

TABLE 3

| | | | Sintering | |
|---|---|---|---|---|
| | Tₘ^{onset} | T_{c}^{onset} | window W | Warpage |
| Example | [° C.] | [° C.] | [K] | [%] |
| C1 | 178.7 | 152.5 | 26.2 | — |
| C2 | 207.4 | 190.7 | 16.7 | 50 |
| I3 | 206.6 | 185.3 | 21.3 | 27 |
| I4 | 206.7 | 173.5 | 33.2 | 13 |
| C5 | 214.1 | 188.8 | 25.3 | — |
| C6 | 214.6 | 189.3 | 25.3 | — |
| I7 | 213.6 | 170.4 | 43.2 | — |
| I8 | 211.5 | 175.6 | 35.9 | — |
| I9 | 212.4 | 178.4 | 34.0 | — |
| C12 | 213.5 | 195.2 | 18.3 | |
| I13 | 212.6 | 187.9 | 24.7 | |

It is clearly apparent from table 3 that the use of at least one additive (A) in the sinter powder (SP) results in a markedly widened sintering window. In addition, warpage is markedly reduced.

1.-13. (canceled)

14. A process for producing shaped bodies by selective laser sintering of a sinter powder (SP) comprising a polyamide (P) and 0.1% to 5% by weight of at least one additive (A), based on the total weight of the sinter powder (SP), wherein the at least one additive (A) is selected from the group consisting of compounds of the formula (I) 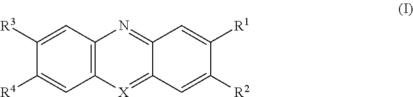
in which
R and R² are independently selected from the group consisting of H, C₁-to C₄-alkyl and NR⁵R⁶,
where R⁵ and R⁶ are independently selected from the group consisting of H and C₁-to C₄-alkyl,
R³ and R⁴ are independently selected from the group consisting of H, C₁-to C₄-alkyl and NR⁹R¹⁰,
where R⁹ and R¹⁰ are independently selected from the group consisting of H and C₁-to C₄-alkyl,
X is N, S⁺ or N⁺R¹³,
where R¹³ is selected from the group consisting of H and C₁-to C₄-alkyl, where the compounds of the formula (I) have a positive charge when X is S⁺ or N⁺R¹³ and the compounds of the formula (I) then comprise an anion Y⁻,
where Y⁺ is selected from the group consisting of hydroxide, chloride, bromide, iodide, sulfate, sulfite, phosphate and phosphite.

15. The process according to claim 14, wherein X in compounds of the formula (I) is N, S⁺ or N⁺R¹³, where the compounds of the formula (I) have a positive charge when X is S⁺ or N⁺R¹³ and the compounds of the formula (I) then comprise an anion Y³¹ , where Y⁻ is selected from the group consisting of hydroxide and chloride.

16. The process according to claim 14, wherein the at least one additive (A) is selected from the group consisting of methylene blue and neutral red.

17. The process according to claim 14, wherein the polyamide (P) is at least one polyamide selected from the group consisting of PA 4, PA 6, PA 7, PA 8, PA 9, PA 11, PA 12, PA 46, PA 66, PA 69, PA 610, PA 612, PA 613, PA 1212, PA 1313, PA 6T, PA MXD6, PA 61, PA 6-3-T, PA 6/6T, PA 6/66, PA 66/6, PA 6/12, PA 66/6/610, PA 6I/6T, PA PACM 12, PA 6I/6T/PACM, PA 12/MACMI, PA 12/MACMT, PA PDA-T and copolyamides formed from two or more of the abovementioned polyamides.

18. The process according to claim 14, wherein the polyamide (P) is at least one polyamide selected from the group consisting of nylon-6 (PA 6), nylon-6,6 (PA 66), nylon-6/6,6 (PA 6/66), nylon-6,6/6 (PA 66/6), nylon-6,10 (PA 610), nylon-6/6T (PA 6/6T), nylon-12 (PA 12) and nylon-12,12 (PA 1212).

19. The process according to claim 14, wherein the sinter powder (SP) has a sintering window (W_{SP}) and the polyamide (P) present in the sinter powder (SP) has a sintering window (W_{P}), where the sintering window (W_{SP}; W_{P}) in each case is the difference between the onset temperature of the melting (T_{M}^{onset}) and the onset temperature of the crystallization (T_{C}^{onset}), and where the sintering window (W_{SP}) of the sinter powder (SP) is at least 5% larger than the sintering window (W_{P}) of the polyamide (P) present in the sinter powder (SP).

20. The process according to claim 14, wherein the particle size of the sinter powder (SP) is in the range from 10 to 250 μm.

21. A process for producing a sinter powder (SP), comprising the following steps:
a) dissolving a polyamide (P) in a solvent (S), with addition of the at least one additive (A) before, during and/or after the dissolution, to obtain a polyamide solution (PS) comprising the at least one additive (A),
b) adding a precipitant (PR) to the polyamide solution (PS) comprising the at least one additive (A) from process step a) to obtain a suspension comprising the sinter powder (SP) suspended in a solution comprising the solvent (S) and the precipitant (PR),
c) separating the sinter powder (SP) from the suspension obtained in process step b).

22. A process for producing a sinter powder (SP), comprising the following steps:
a) heating a mixture comprising a polyamide (P) and a solvent (S) to a temperature greater than the cloud temperature (T_{C}) above which the polyamide (P) dissolves completely in the solvent (S), with addition of the at least one additive (A) before, during and/or after the heating, to obtain a polyamide solution (PS) comprising the at least one additive (A),
b) cooling the polyamide solution (PS) which comprises the at least one additive (A) and has been obtained in process step a) to a temperature of not more than the cloud temperature (Tc) and subsequently adding a precipitant (PR) to obtain a suspension comprising the sinter powder (SP) suspended in a solution comprising the solvent (S) and the precipitant (PR),
c) separating the sinter powder (SP) from the suspension obtained in process step b).

23. The process according to claim 21, wherein the solvent (S) is selected from the group consisting of alcohol, lactam and ketone.

24. The process according to claim 21, wherein the precipitant (PR) comprises at least 50% water, based on the total weight of the precipitant (PR).

25. The process for producing shaped bodies by selective laser sintering according to claim 14, wherein the sinter powder (SP) is produced by a process according to claim 21.

26. A shaped body obtained by the process according to claim 14.
